(19) United States
(12) Patent Application Publication
(10) Pub. No.: US 2004/0184353 A1
(43) Pub. Date: Sep. 23, 2004

(54) Latch for transom mounted marine instrument

(75) Inventor: Robert Cullen, Temple, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Airmar Technology Corporation, Milford, NH

(21) Appl. No.: 10/737,526

(22) Filed: Dec. 15, 2003

Related U.S. Application Data
(60) Provisional application No. 60/444,991, filed on Feb. 4, 2003.

(51) Int. Cl. H04R 1/00

(52) U.S. Cl. 367/179

(57) ABSTRACT

A releasable latch for a marine instrument is provided for a transom mounted sensor on a marine vessel which enables the sensor to be rotated about a pivot point when an object is struck by the vessel.

### RELATED APPLICATION

This application claims the benefit of U.S. Provisional Application No. 60/444,991, filed Feb. 4, 2003. The entire teachings of the above application are incorporated herein by reference.

### BACKGROUND OF THE INVENTION

This invention is in the field of marine instrumentation for providing information with respect to the speed of a marine vehicle through water, and optionally, with respect to the depth and temperature of the water.

Instruments for measuring and displaying speed or velocity of a marine vessel through water have utilized a wide variety of sensors (See, for example, U.S. Pat. No. 4,206,637- paddlewheel interrupts photodetector; U.S. Pat. Nos. 3,496,770; 3,457,782—paddlewheel with magnet on each paddle or paddle made of magnetic field permeable material which is sensed by electromagnetic pick-up coil; and U.S. Pat. No. 3,706,224—paddlewheel with magnet on each paddle which interrupts current flow in a circuit).

Similarly, numerous instruments exist for providing ultrasonic signals for depth sounding or fish locating. (See, for example, U.S. Pat. No. 4,110,727 and various references cited therein.)

It has also been found helpful for marine navigation and fish finding to measure water temperature by various means.

For the most part, prior art speedometers are mounted through the hull of the vessel requiring the drilling of a large hole in the hull and the attendant sealing problems (See the knotmeter of U.S. Pat. No. 3,531,988 referenced above). Additionally, with the exception of the transom mounted speedometer, it is customary to completely enclose the paddlewheel speed sensor except for a small portion in which the paddle extends into the water (See U.S. Pat. No. 3,457,782 above, for example). In such “closed cavity” devices, the speed sensor becomes non-linear at higher speeds of, for example, in excess of 35 miles per hour.

U.S. Pat. No. 4,555,938 discloses a marine device which combines in one transom mounted housing the functions of speed sensing, water temperature sensing and depth or fish sounding. In the apparatus of U.S. Pat. No. 4,555,938, a sensor housing is provided for enclosing an ultrasonic transducer assembly, and a temperature sensor comprising a thermistor.

In addition, a paddlewheel, or impeller, is attached to the housing. The paddlewheel is formed of amorphous magnetic material and the blades are magnetized to provide alternate North-South poles. As the marine vessel moves through water, the paddlewheel rotates at a rate proportional to the velocity of the vessel. A Hall-effect device mounted inside the housing adjacent the paddlewheel senses the change in electromagnetic field, as the polarized rotating paddlewheels pass by, and generates an electrical signal, the frequency of which is proportional to vessel speed.

Electrical leads running from the ultrasonic transducer, Hall-effect device, and thermal sensor are coupled to appropriate interface circuitry and display devices on the vessel.

Generally, the housing is rigidly attached to the vessel such that in the event the bottom of the vessel hits an obstacle, damage to the marine device is likely to occur.

### SUMMARY OF THE INVENTION

A rotatable mounting bracket is provided for a marine sensor device attached to a marine vessel and which enables the device to be freely pivoted about a pivot point by releasing a locking latch. The rotatable bracket couples a sensor housing to a fixed member on the marine vessel.

In one embodiment, a speed sensor is contained in the housing; the speed sensor may be a rotatable magnetized paddlewheel disposed adjacent an electromagnetic sensor and extending aft of the vessel.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is partial perspective view of a first embodiment of the invention showing a transducer assembly 4 which attaches to a marine vessel (not shown).

FIG. 2 is a partial plan top view of FIG. 1 in which the modular speed sensor sub-assembly 14 of FIG. 1 has been removed from the housing 10 and wherein the housing 10 is shown in a “latched” position in which the housing is latched onto fixed bracket 12.

FIG. 3A is a partial sectional side view along the lines B-B of FIG. 2.

FIG. 3B is a partial side view of FIG. 1 showing the removable sub-assembly 14.

FIG. 4 is a partial plan top view as in FIG. 2 wherein the housing is “unlatched” from the fixed bracket 12.

FIG. 5A is a partial sectional side view along the lines C-C of FIG. 4.

FIG. 5B is a side view of a cosmetic cover 90 of an alternate embodiment.

FIG. 6 is a perspective view of the completed invention with certain internal items shown.

### DETAILED DESCRIPTION OF THE INVENTION

A description of preferred embodiments of the invention follows.

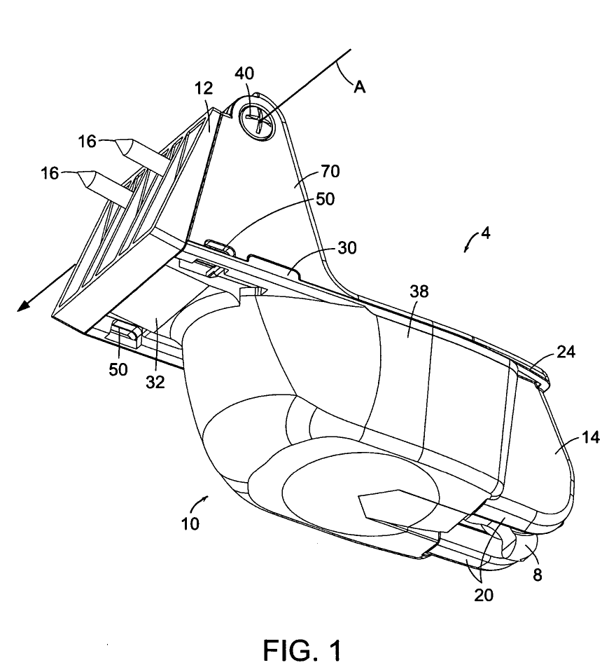

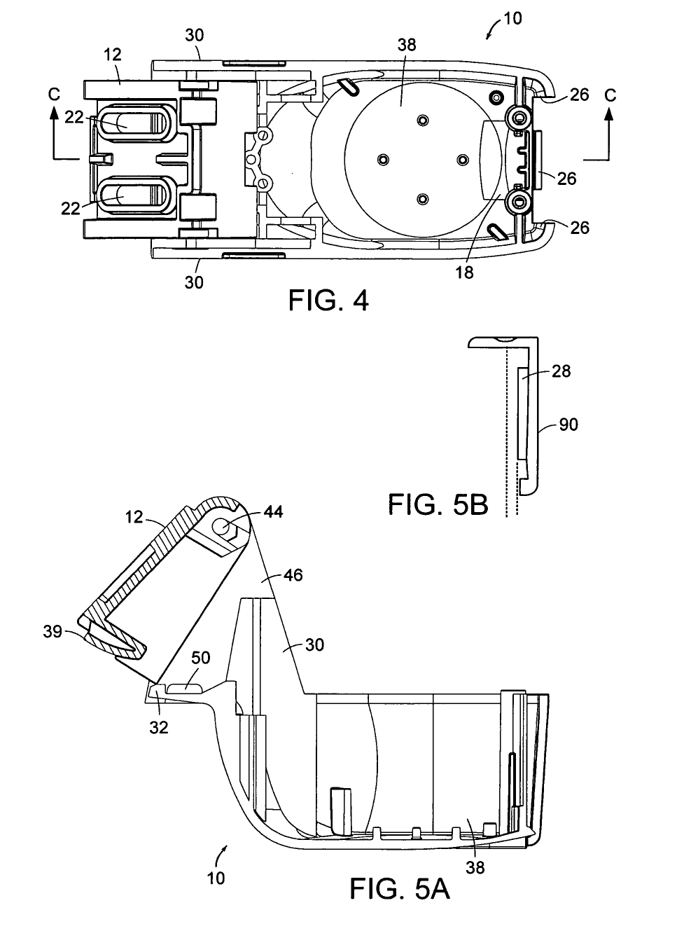

Referring to FIGS. 1-6, a transom mount transducer assembly 4 may be seen to comprise, in general, a housing 10, a cover 70, and a fixed bracket 12. The housing comprises a rotatable bracket 30, sensor housing 38, and external mount 26. The rotatable bracket 30 rotatably connects to the fixed bracket 12 which attaches by bolts 16 to a marine vessel (not shown). The fixed bracket comprises mounting slots 22 which enable the assembly to be adjustably mounted to the marine vessel (not shown) with bolts 16.

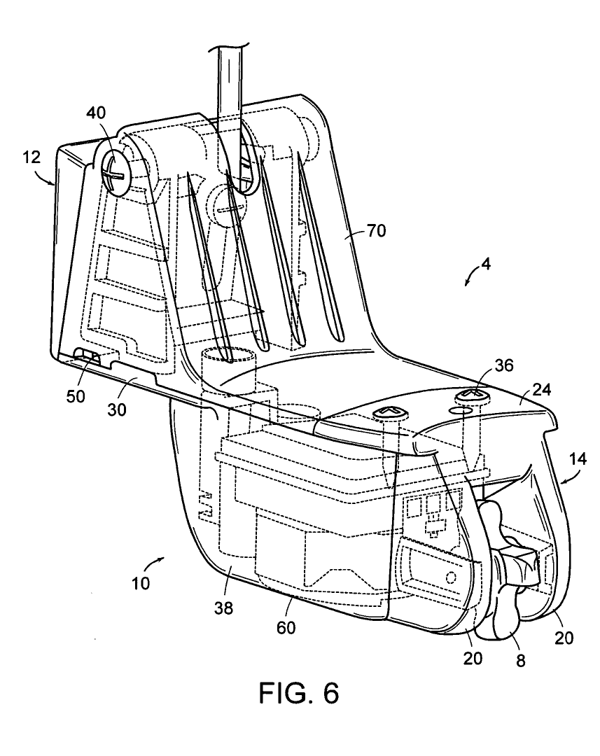

The sensor housing 38 is comprised of electromagnetically permeable material, such as polycarbonate. An ultrasonic transducer assembly 60 (FIG. 6) is centrally mounted within the walls of the housing 10. The ultrasonic transducer assembly comprises a copper or other electrically conductive material forming an electromagnetic shield about a piezoelectric transducer. The piezoelectric transducer consists of a piezoelectric device which, upon being provided with an appropriate alternating electrical signal, produces a mechanical vibratory force which is transmitted into the water and, upon return of this signal, the transducer converts the mechanical vibratory signal into a corresponding electrical signal, which may be displayed on an appropriate meter provided on the vessel (not shown).

A paddlewheel sub-assembly 14 or cosmetic cover 90 may be optionally attached to the external mount 26 of the housing 10. As shown in FIG. 5B, the cosmetic cover 90 may be used in place of the paddlewheel sub-assembly 14 for users not interested in having a speed sensor function but still desirous of having a depth sounding capability.

The paddlewheel sub-assembly 14 comprises a paddlewheel 8 rotatably mounted between a pair of struts 20 attached to a frame 24.

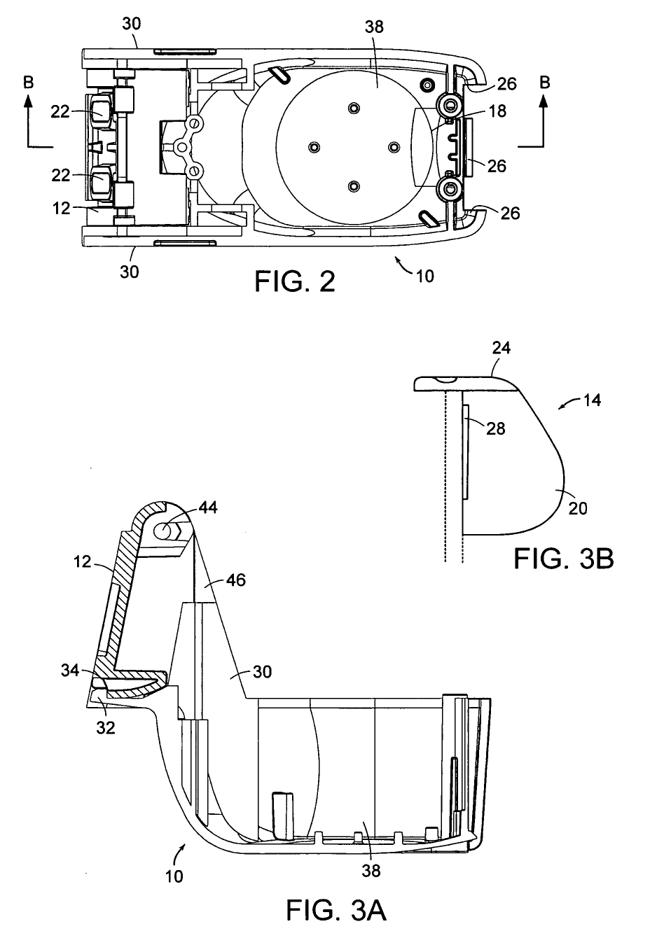

Preferably, an electromagnetic sensing (Hall-effect) device 18 (FIGS. 2,4) is mounted on the inner aft wall of sensor housing 10. However, in other embodiments the Hall-effect device 18 may be mounted within the paddlewheel sub-assembly 14.

The paddlewheel 8 consists of a hub portion from which extends a plurality of paddles. The paddlewheel 8 is formed of amorphous magnetic material, such as barium ferrite. After formation of the paddlewheel 8, the paddles may be electromagnetically polarized in a magnetic field, such that the polarity of the paddles at the tip alternates from north to south.

As the paddles rotate about a shaft, the variation in electromagnetic field caused by the polarity changes, is sensed by the Hall-effect device 18 mounted on the interior aft wall to the sensor housing 10. In operation, the paddlewheel 8 is adapted to be mounted on the transom of a vessel in a position such that the paddles pierce the surface of the water when the vessel is planing.

As the paddles of the paddlewheel 8 rotate past the Hall-effect device 18, an alternating voltage signal is generated. The frequency of the voltage signal is directly proportional to the rotational speed of the paddle-wheel and, therefore, to the velocity of the vessel.

In accordance with the present invention, paddlewheel assembly 14 is adapted to be separably mounted onto sensor housing 10 for convenience of removal for replacement or cleaning purposes or where the end user does not require a speed sensor function. This separability is achieved by the interrelationship between the external mount 26 on the housing 10 and the locking tabs 28 on the struts 20 of the paddlewheel assembly 14. Once assembly 14 is mounted, as shown by the dotted lines in FIG. 3B, screws 36 (FIG. 6) may be engaged to secure the sub-assembly in place.

Oppositely disposed pivot holes 44 are formed, as by molding or drilling, the upper portion 46 of the rotatable bracket 30 of housing 10, cover 70, and fixed bracket 12. Tightening screws 40 connect to each other through pivot holes 44 to provide for rotational motion about the axis A of FIG. 1.

It should be noted that in the event the housing 10 is subjected to excessive forces, particularly in the rearward direction (for example, by striking an object in the water), the compressive forces formed by the tightening screws 40 together are adapted to be overcome before the plastic housing breaks in which case housing 10 is, thereby, enabled to rotate counterclockwise (as viewed in FIGS. 1-6), thereby releasing the assembly upward, for pivotal or rotational movement about the axis A.

More importantly, referring now to FIG. 3A, it may be seen that housing 10 is more securely rotatably fastened to fixed bracket 12 (mounted on the vessel) by coupling a flexible leading edge member 32 of housing 10 to a lip 34 of the fixed bracket 12.

FIGS. 1 and 5A illustrates how housing 10 may be more readily disengaged from fixed bracket 12 by inserting a screwdriver or other suitable object into slot 50 to deflect the flexible leading edge member 32 downwardly to release the lip 34 of the fixed bracket 12, thereby enabling the housing 10 to be freely rotated counterclockwise (as viewed in FIGS. 1-6) and released from the fixed bracket 12 for various reasons, such as inspection and cleaning or repair. This method of disengaging the housing allows a user to access the housing without having to exert the pivot release force necessary to pivot the housing when the vessel strikes an object under speed. Because the housing is made of plastic, many users are reluctant to use such force for fear of breaking the bracket.

A cover 70 (FIGS. 1,6) may be affixed over the housing 10 to complete the assembly.

While this invention has been particularly shown and described with references to preferred embodiments thereof, it will be understood by those skilled in the art that various changes in form and details may be made therein without departing from the scope of the invention encompassed by the appended claims.

What is claimed is:

1. Apparatus for rotatably mounting a marine sensor on a vessel wherein the sensor is provided in a housing attached to a fixed bracket, whereby the housing is releasably latched to the fixed bracket.

2. The apparatus of claim 1 wherein the housing includes a latch which releasably mates with the fixed bracket.

3. The apparatus of claim 2 wherein the latch includes an edge member for engaging a forward directed lip on the fixed bracket.

4. The apparatus of claim 3 wherein the fixed bracket may be released by disengaging the edge member of the latch.

5. The apparatus of claim 3 wherein at least one slot is provided to disengage the edge member from the fixed bracket.

6. The apparatus of claim 1 wherein the marine sensor may include one or more of a depth sensor, a temperature sensor, and a speed sensor.

7. The apparatus of claim 6 wherein the speed sensor is a paddlewheel sensor which is removably attached to the housing.
